(19) United States
(12) Patent Application Publication
(10) Pub. No.: US 2008/0077685 A1
(43) Pub. Date: Mar. 27, 2008

(54) Dynamically configurable presence service

(75) Inventors: Hong Thi Nguyen, Atlanta, GA (US); Michael Sean Denny, Sharpsburg, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/525,008

(22) Filed: Sep. 21, 2006

(51) Int. Cl. G06F 15/16; G06F 15/173

(52) U.S. Cl. 709/224; 709/204

(57) ABSTRACT

A dynamically configurable presence service provides support for heterogeneous presentities. Presentity types are registered using a presentity manifest that includes information such as type names, addresses of applications associated with actions related to the presentity type, application parameters, icons for watcher application, and the like. Users (watchers) can then register for different groups of presentities based on type and receive updated presence information. Watcher applications are dynamically configured for presentation and management purposes based on updated presentity type information.

### RELATED APPLICATIONS

The present application may be found to be related to U.S. patent application entitled: “PERSONAL PRESENTITY PRESENCE SUBSYSTEM”, Ser. No. ______, filed with the USPTO on the same day as this patent application, Attorney Docket Number 60027.526US01/BS060214.

### TECHNICAL FIELD

Embodiments are related to presence services. More particularly, the disclosed subject matter is related to computer-implemented methods, configurations, systems, and computer program products for facilitating support for different presentity types and real time configurability for presentities in a presence service.

### BACKGROUND

Today's presence standards, models, and presence service implementations typically require customization and/or development for integrating and presenting applicable actions that can be performed when a presence notification for a presentity has been received. For example, a presence application may have embedded logic on which actions can be performed when a presence notification is received.

Furthermore, presence services usually assume a homogeneous presentity population, addressing only one type of presentity, typically persons. When a user turns on their cell phone, a notification is sent to the presence service which in turn sends a message to “watchers” who are monitoring that user. The “watcher” may have client software, which may include embedded logic about the services associated with the user and the actions that can be taken in association with the user services. When a new type of presentity is added to the presence service, the client software may have to be upgraded to add the process logic associated with this presentity.

### SUMMARY

Consistent with embodiments described herein, systems and methods are disclosed for providing support for real time configurability for presentities and different types of presentities in a presence system. Key features or essential features of the claimed subject matter are not necessarily identified in this summary portion.

Embodiments are directed to a presence service and a dynamically reconfigurable presence application. Presence service is arranged to register and maintain updated information on different presentity types. Presence applications are provided presentity type information such that they can subscribe to groups of presentities based on the presentity types. Upon subscribing to a group of presentities, the presence applications are dynamically reconfigured with type information such as type name, application addresses associated with actions for each presentity type, icons to be used for the presentity type, authorizations, and the like. The types may include presentities comprising devices or systems associated with a particular user.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 illustrates a conceptual diagram of a presence service architecture, where example embodiments may be implemented;

FIG. 2 illustrates main components of an example dynamically configurable presence system architecture;

FIG. 3 illustrates action flows in the example dynamically configurable presence system of FIG. 2;

FIG. 4 illustrates an example presence application UI; and

FIG. 5 illustrates a logic flow diagram for a process of providing a dynamically configurable presence service according to one embodiment.

### DETAILED DESCRIPTION

As briefly described above, a presence service may include real time configurability for different types of presentities. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

Referring now to the drawings, aspects, exemplary operating environments, and configurations will be described. While the embodiments will be described in the general context of program modules that execute in conjunction with an application program that runs on an operating system on a personal computer, those skilled in the art will recognize that aspects may also be implemented in combination with other program modules.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

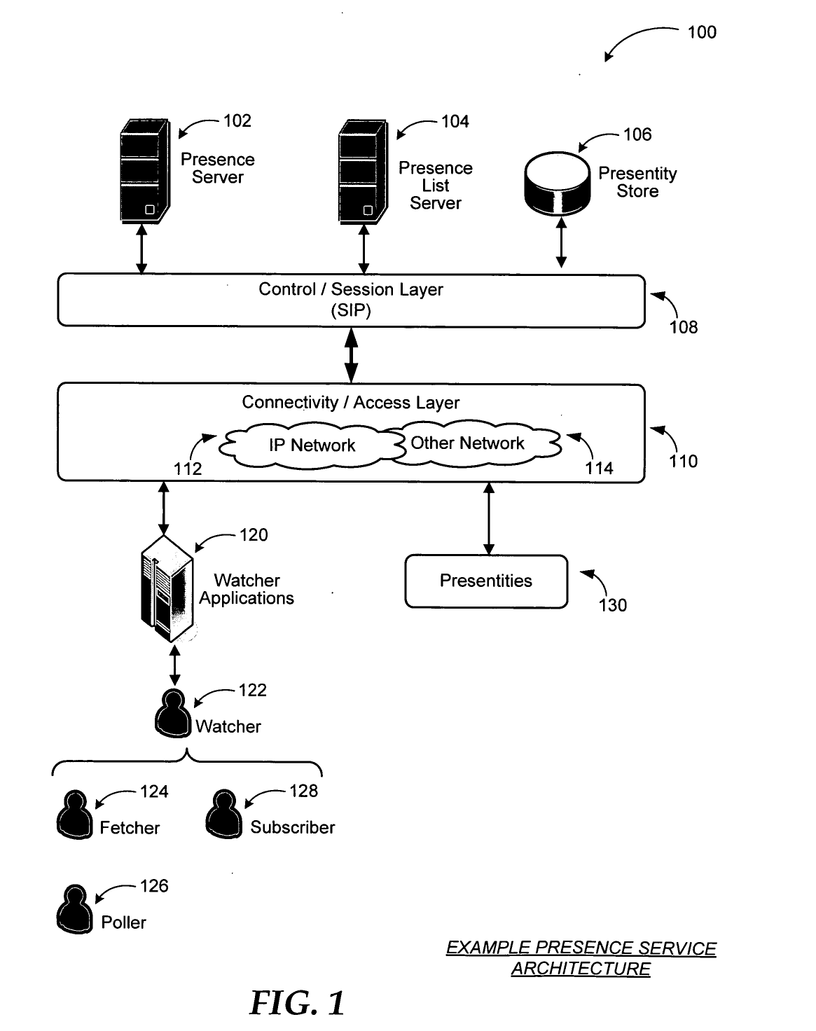

FIG. 1 and the following discussion are intended to provide a brief, general description of a suitable computing environment in which the invention may be implemented. With reference to FIG. 1, a conceptual diagram of a presence service architecture 100, where example embodiments may be implemented, is shown. A presence system allows users to subscribe to each other and be notified of changes in state and, typically, for users to exchange a communication with each other. A presence service has two distinct sets of “clients”. One set of clients, called “presentities”, provides presence information to be stored and distributed. The other set of clients, called “watchers”, receives presence information from the service.

Architecture 100 includes at a base level watcher applications 120 and presentities 130 that connect to a backbone of the presence system through IP network 112 or other network(s) 114 of a connectivity and access layer 110. Watcher applications 120 provide an interface for watcher(s) 122. There are two kinds of watchers, called “fetchers” 124 and “subscribers” 128. Fetcher 124 simply requests the current value of some presentity's presence information from the presence service. In contrast, subscriber 128 may request notification from the presence service about changes in a presentity's presence information including future changes. A special kind of fetcher is one that fetches information on a regular basis. This is called a “poller” 126.

In a conventional presence system, watcher applications may be executed on computing devices such as cellular phones, Personal Digital Assistants (PDAs), and the like, providing information about the presentities that are typically associated with a particular watcher. In a typical presence system scenario, the presentities may include people in a phone subscriber's “buddy list” with the system providing information about location or contact information of the people on the buddy list to the subscriber and enabling the subscriber to contact the presentities through various means. Thus, the presentities in a typical presence system are homogeneous (all persons). Furthermore, the presence services generally operate by registering the presentities along with their attributes requiring a reconfiguration of the buddy list when a new presentity is added or one removed.

According to some embodiments, presentities 130 may include different types of presentities such as interface devices (and applications) that may provide a service to the watcher 120. For example, a monitoring or entry system configured to provide triggering event(s) to the watcher 120 and facilitate actions in response to the triggering event(s) and the watcher's selection, may be defined as a presentity 130.

Connectivity and access layer 110 includes network infrastructure that is used to provide interconnection between presentity 130, watcher applications 120, and presence service applications at higher levels of the system. Connectivity layer 110 may include IP network 112 and other network 114 or a combination of networks. These network(s) 112 and/or 114 may include a secure network such as a home network or an enterprise network, or an unsecure network such as a wireless open network. The networks 112 and/or 114 provide communication between the applications described above. By way of example, and not limitation, the networks 112 and/or 114 may include wired media such as a wired network or direct-wired connection, and wireless media such as acoustic, RF, infrared and other wireless media.

Presence services may be a service component deployed within an IP Multimedia System (IMS) framework. Control and session layer 108 is arranged to facilitate communication sessions between physical devices and applications, as well as between the applications and any network resources such as data stores of the IMS framework. IMS is an open-systems architecture that supports a range of IP-based services over both packet switch and circuit switch networks, employing both wireless and fixed access technologies.

IMS provides services and control such as adding call session control to a packet network, enabling peer-to-peer real-time services such as voice or video over a packet-switched domain, and scalable common service control (based on SIP) for giving the ability to manage parallel user services. In a mixed multimedia environment, IMS may provide the ability to pick and mix various multimedia flows in single or multiple sessions and can handle real-time voice, video, and data. IMS also provides access to IP based services independent of the underlying access technology (mobile or fixed). IMS applications and drivers may include voice telephony (VoIP), video telephony, web browsing, presence-based services, push-to media services (e.g. push-to-talk, push-to-view, push-to-video, etc.), group chat, instant messaging, multimedia conferencing, content sharing/data transfer, and the like.

Control and session layer 108 within an IMS framework may include components such as proxy-call state control function (“P-CSCF”), which is typically a first point of contact and may provide privacy control, quality of service (“QoS”), authorization of local services, and similar functionalities. P-CSCF may interacts through SIP with interrogating-call state control function (“I-CSCF”), which may provide an access point functionality to the network and enable protection of a topology and configuration of the network. I-CSCF may interact through SIP with serving-call state control function (“S-CSCF”), which provides session control services such as registration, accounting, and the like. Both I-CSCF and S-CSCF may interact with a home subscriber service (“HSS”), which can be used as a data store service for storing presence information, e.g. where the user can be reached. An IMS architecture may include additional components such as a subscriber locating function, a trunking signaling gateway, a media resource function controller, and the like. Furthermore, control and session layer 108 may also be embodied within a framework other than IMS.

Presence server 102, presence list server 104, and presentity store 106 are at an application layer 105 of architecture 100. The application layer 105 may also include one or more applications associated with providing additional services to the watchers 122 integrated with the unified presence service.

Presence server 102 is arranged to coordinate exchange of information between the presentities 130 and watchers 122, as well as different data stores of the system. For example, presence server 102 may receive information associated with a location of a watcher 122 and notify the watcher 122 through an application (or device) based on the watcher's location about status of the watcher's registered presentities 130. Presence list server 104 may maintain a list of the presentities 130 associated with each watcher 122 and update presentity store 106, where information about the presentities 130 and their attributes are stored.

According to some embodiments, watchers 122 and presentities 130 may include one or more user interfaces (‘“UIs”) to receive and provide information, such as VoIP communications, action selections, alphanumeric entries, and the like.

Interface devices executing watcher 122 and presentity 130 applications as well as servers of the application layer 105 may include or may be part of a computing device. Such a computing device may include, but is not limited to, a handheld computer, a Personal Digital Assistant (PDA), a TV, an MP3 player, a smart remote control device, and the like. Computing devices typically include a processing device and a system memory. Computing devices may also include additional processing devices, which may be dedicated processors or enable distributed processing by coordinating with a main processing device. The system memory may be volatile (such as RAM), non-volatile (such as ROM, flash memory, etc.) or some combination of the two. System memory typically provides an environment for an operating system to be executed for controlling the operation of the computing device and execution of other programs (applications). The watcher application 120, a subscriber location application, two-way communication applications, imaging or video communication applications are examples of programs or program modules that may be executed in the system memory. These applications may be an integrated part of a single program or separate applications. They may communicate with other applications running on the computing device or on other devices.

The computing devices may have additional features or functionality. For example, the computing devices may also include data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. The system memory and storage devices are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. Any such computer storage media may be part of the computing device.

Computing devices may also include input devices such as a keyboard, a keypad, a voice input device, a touch input device, a camera etc. Furthermore, output devices such as a display, a speaker, a printer, etc. may also be included. These devices are well known in the art.

Communication connections may be included in the computing devices to allow the device to communicate with other computing devices executing above described applications, such as over a network in a distributed computing environment, for example, an intranet or the Internet. Communication connections may include media that may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media. The implementation of embodiments for interface devices and servers of a dynamically configurable presence subsystem is not limited to the computing devices described above. Other computing devices with different components, configurations, and the like, may be used to execute computer readable instructions implementing embodiments described herein without departing from a scope and spirit of the disclosed subject matter.

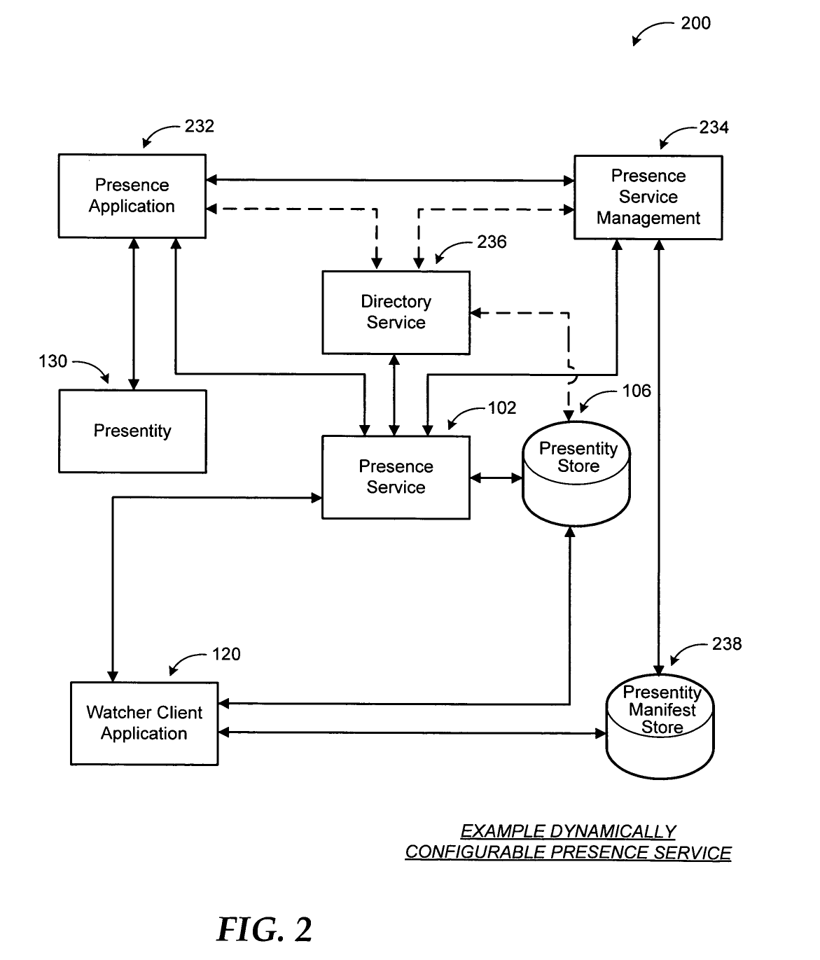

FIG. 2 illustrates main components of an example dynamically configurable presence system 200. According to some embodiments, the presence system 200 may provide for real time configurability of a presence application to dynamically determine and configure the actions that can be taken when a presence notification has been received. According to other embodiments, the system 200 may support different types (heterogeneous) of presentities which may have different associated service actions.

The support for heterogeneous presentities with different associated service actions may be accomplished by employing a presentity manifest. For each presentity 130 a presentity manifest including a type of the presentity 130, a list of associated actions, a presentity group information, and a list of authorized watchers 122 may be stored within presentity manifest store 238 and maintained by the presence server 102. Furthermore, the list of associated actions may include for each action a network address of an application or system to connect to, one or more parameters for the application or system associated with the action, and presentation information (e.g. icons to be used in a UI for the action).

In an operation, presence application 232 may monitor presence of presentities such as presentity 130 and update presence server 102 with the status of monitored presentities 130. Presence application 232 may also register any new presentity type with presence service management component 234. Moreover, presence application 232 may optionally register presentities 130 with directory service 236.

Presence service management component 234 may register any applications associated with presentities 130 with presence server 102 as well as register any new presentities 130 with directory service 236. According to some embodiments, presence service management component 234 may store new presentity types and manifests of the presentities 130 with presentity manifest store 238.

Watcher application 120 may be dynamically reconfigured based on the presentity manifests in presentity manifest store 238. For example, profiles, associated actions, and icons for each presentity 130 displayed on a watcher application UI may be updated when the presentity manifest is modified in presentity manifest store 238. Watcher application 120 also subscribes to selected presentities 130 with the presence server 102 and receives updates on presence information (e.g. location, status of a presentity). Watcher application 120 may receive the updates from presence server 102 or directly from presentity store 106.

Presence server 102, in coordination with directory service 236, manages presentity store 106 where status information associated with registered presentities 130 is stored. As mentioned above, the interactions between the components of the dynamically configurable presence system 200 may be facilitated within an IMS framework using SIP sessions. A basic example scenario is provided below for illustration purposes.

According to the example scenario, the presence service 200 may support three types of presentities 130: persons (contacts in a buddy list), monitoring system interface devices (car alarms equipped with cameras), and entry system interface devices (doorbells equipped with visual and audio communication devices). Each type of presentity 130 has different actions associated with it such as “call” for persons, “take picture” for car alarm, and “audio call” or “video call” for the doorbell. Thus, each type of presentity 130 has different applications that need to be activated to perform the associated action(s). When the presentities 130 are added to the system 200, their manifests including their types (e.g. person, car alarm, doorbell), the network addresses of the associated applications (e.g. IP addresses for client phone application, client image acquisition application, and the like), any parameters associated with the applications, and icons for the actions may be stored in presentity manifest store 238.

Under each type, there may be numerous presentities 130 (e.g. an extensive buddy list of contacts, three separate car alarms, front and back doorbells, etc.). Presence server 102 may categorize added presentities 130 once they are registered by presence application 232. When the presentity manifest store 238 is updated, watcher application 120 may be dynamically updated to reflect the latest configuration for different presentity types.

Watcher application 120 then receives updates on the presentities 130 from the presence server 102. In response to the received updates, watcher application 120 may select an associated action (e.g. initiate an audio call with a person at the door in response to the doorbell being rung). Presence server 102 in coordination with presence application 232 may then manage activation of the appropriate presentity application 232 and facilitate the execution of the action.

The architecture and scenarios described in FIG. 1 and FIG. 2 are for illustration purposes only and do not constitute a limitation on embodiments. Other configurations of a dynamically configurable presence system 200 may be implemented without departing from a scope and spirit of the present invention.

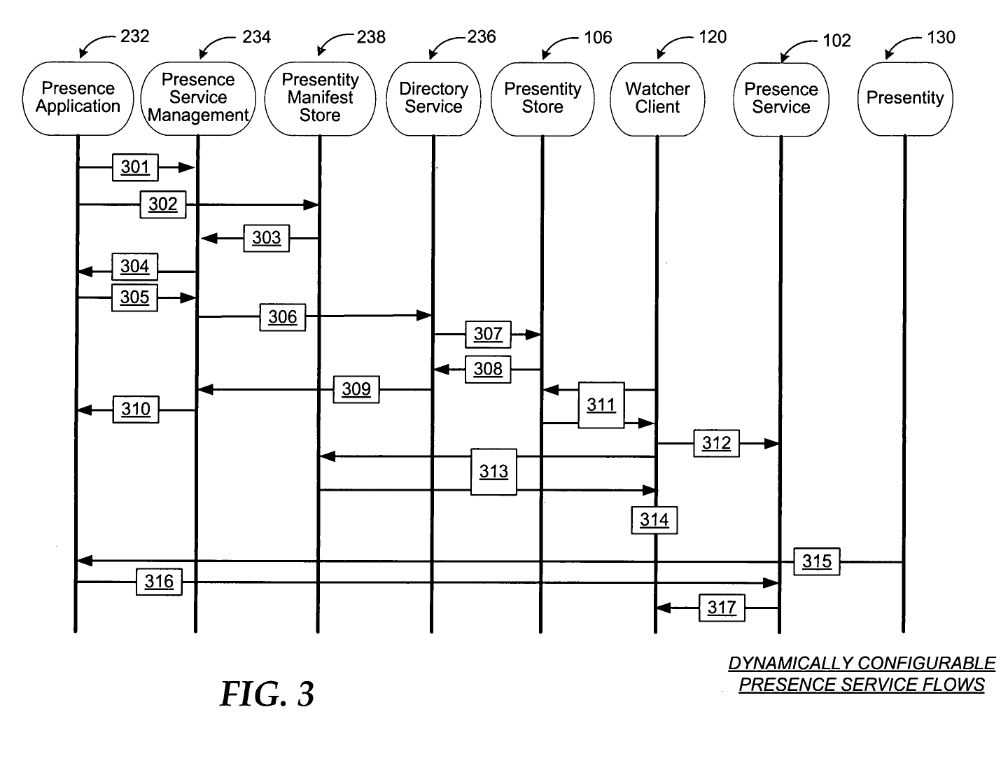

FIG. 3 illustrates action flows in the example dynamically configurable presence system 200 of FIG. 2. The interactions are between components the presence system 200 described above in detail.

The action flow begins with action 301, where presence application 232 performs an initial registration of a presentity type that includes the manifest information discussed above in conjunction with FIG. 2. The registration is performed with presence service management component 234. Presence application 232 then stores the manifest information with presentity manifest store 238 in action 302. Actions 303 and 304 are respective responses of presentity manifest store 238 and presence service management component 234 that registration is complete. Upon receiving the registration complete message, presence application 232 registers a presentity 130 with presence service management component 234 in action 305. In response, presence service management component 234 registers the presentity 130 with directory service 236 in action 306. Following that, directory service 236 registers the presentity 130 with presentity store 106 in action 307 and receives a registration complete message in action 308. The registration complete message is forwarded to presence service management component 234 in action 309 and from there to presence application 232 in action 310.

In the meantime, watcher application 120 retrieves one or more types of presentities 130 from presentity store 106 in actions 311. Watcher application 120 then subscribes to presentities 130 by type with presence server 102 in action 312. Following the subscription, watcher application 120 retrieves the manifest(s) for the subscribed presentities 130 from presentity manifest store 238 in actions 313. The retrieval of the updated manifests results in dynamic reconfiguration of the watcher application 120 in action 314, which may include updating one or more UIs, application parameters, links, and the like.

In action 315, presentity 130 provides presence application 232 with presence information. This may include information such as a doorbell ringing status, a car alarm status, availability of a person for phone call, and the like. Other types of presentities 130 may also be included in the presence system 200. For example, automated service resources such as soda vending machines may form one type of presentity 130. A watcher 122 may subscribe to a sub-group of soda vending machines such as those carrying a particular brand of soda. Once the watcher 122 subscribes to the “buddy list” of vending machines carrying his/her particular brand, the watcher 122 may get updated information on location of nearby vending machines and whether they carry the brand or not. Another example scenario may include a commercial resource such as restaurants as a presentity 130. The watcher 122 may select any group of restaurants for his buddy list (fast food, Mediterranean food, etc.) and find out whether the restaurant is open or closed as presence information. Users can take additional actions to find out a location and operation hours of restaurants in their buddy list if desired. The presence application 232 updates presence server 102 with the information from the presentity 130 in action 316. Presence server 102 then updates watcher application 120 in action 317.

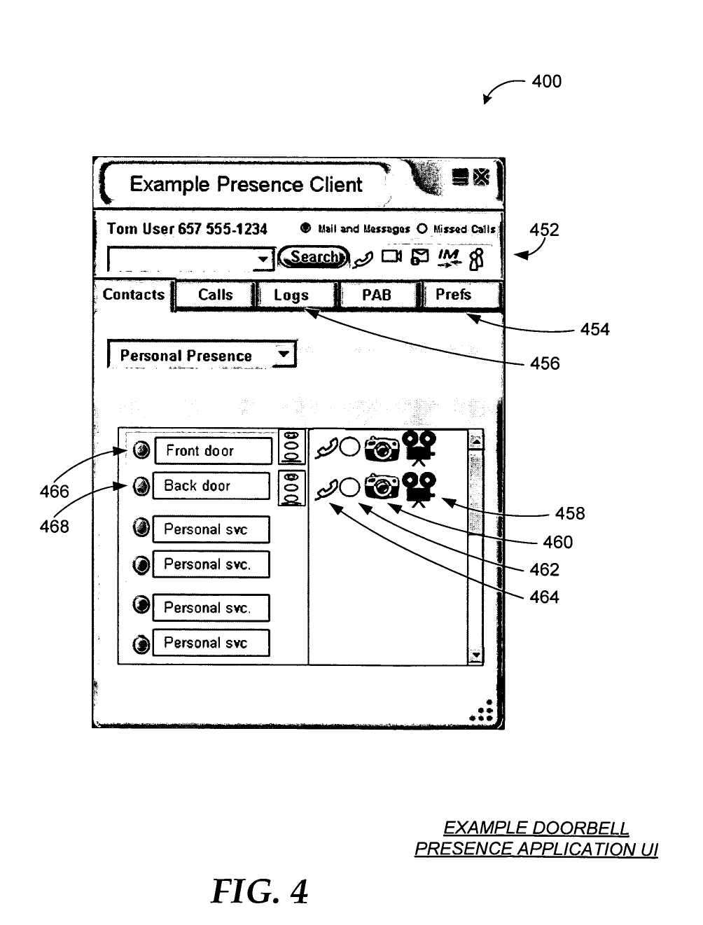

FIG. 4 illustrates an example presence application UI 400 that may be part of a watcher application 120 executed on a user device. In the specific example shown in FIG. 4, UI 400 is part of a doorbell presence service application 232, which uses a doorbell presence hardware as a presentity 130 to provide notification to a watcher 122 (resident) and to perform actions selected by the watcher 122 in response to the notification.

According to some embodiments, presence application 232 may notify the user and present with actions to select, as well as the actions executed using the same computing device. In other embodiments, any combinations of the above described events may be presented using separate computing devices.

UI 400 may include additional functionality such as phone service, instant message service, email service, and the like, as shown with icons 452. Different tabs may be provided for various aspects of the UI 400 such as tab 454 (Preferences) for configuration changes, tab 456 (Logs) for recorded information. For a doorbell presence service, the UI may provide different indicators for different presentities 130 (entry points) such as front door 466 and back door 468. The UI 400 may provide notification that someone is at the door by changing a color of the indicator icon to the left of the location designator or the designator itself. Other methods such as flashing the designator, highlighting the designator, and the like, may also be used. Another icon 465 to the right of the location designator indicates the presence of a doorbell presence hardware at the designated location.

Next, a number of icons 458, 460, 462, and 464 next to each location designator show available actions for that location. For example, both the back door 468 an front door 466 are equipped with doorbell presence hardware capable of establishing VoIP call icon 464, taking picture icon 460, and obtaining a video of the visitor icon 458. The icons and actions listed for each presentity 130 on UI 400 may be dynamically configured based on updates received from the presence server 102, e.g. through presentity manifest store 238 updates. A watcher application 120 and its associated UI(s) may of course include fewer or additional functions and present them in other configurations including, but not limited to, drop down menus, panes, separate view screens, and the like.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

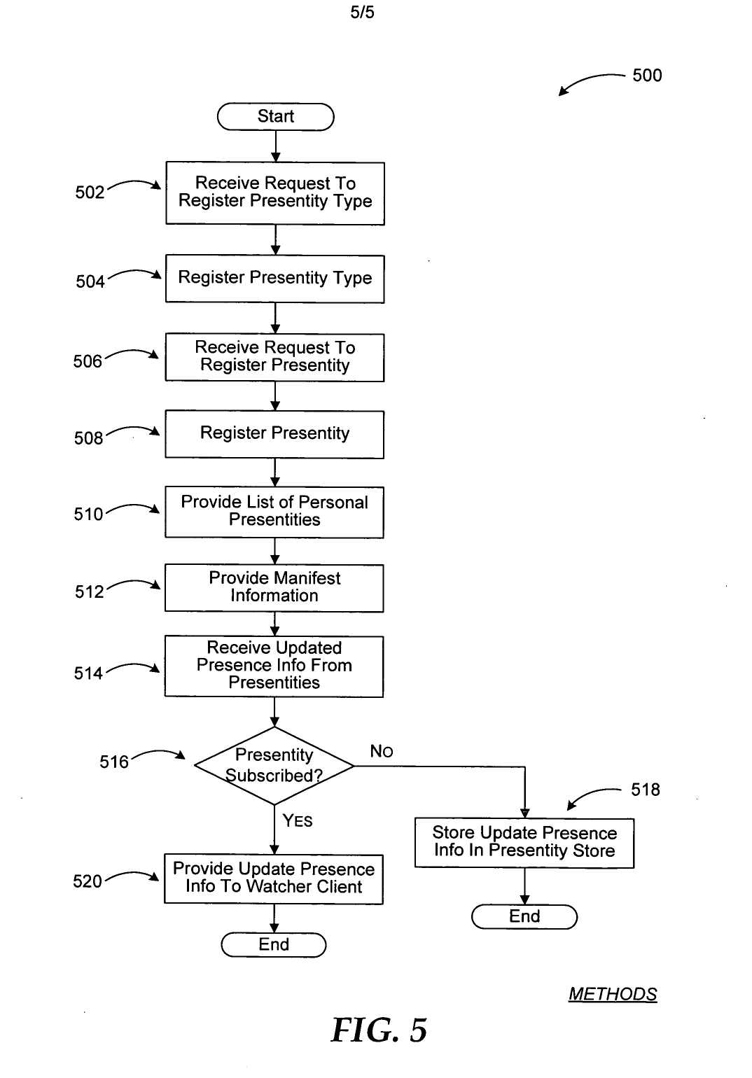

FIG. 5 illustrates a logic flow diagram for a process 500 of providing a dynamically configurable presence service according to one embodiment. Process 500 may be implemented in presence server 102.

Process 500 begins with operation 502, where presence service management component 234 receives a request for registering a presentity type from presence application 232. The request may include information associated with the presentity type such as name of the type, addresses of applications associated with related actions, icons to be presented in a watcher application UI for the presentity type, and the like. Processing moves from operation 502 to operation 504.

At operation 504, the presence service management component 234 registers the presentity type with presentity manifest store 238 and confirms the registration to the requesting presence application 232. Processing moves from operation 504 to operation 506.

At operation 506, presence service management component 234 receives a request for registering a presentity 130 belonging to one of the registered types. The registered types may include personal presentities 130, which may comprise of devices and systems associated with a watcher 122 such as doorbell presence hardware, car alarms, equipment monitoring devices, and the like. Processing moves from operation 506 to operation 508.

At operation 508, the presence service management component 234 registers the presentity 130 with presentity store 106 and confirms the registration to the requesting presence application 232. Processing moves from operation 508 to operation 510.

At operation 510, presentity store 106 provides a list of presentities 130 to watcher application 120, which may subscribe to a subset of those with presence server 102. Upon subscribing to the group of presentities 130, the watcher application 120 may request the manifests of the presentities 130 in the group from presentity manifest store 238. Processing moves from operation 510 to operation 512.

At operation 512, presentity manifest store 238 provides the manifests of the presentities 130 in the list of subscribed presentities 130 to the watcher application 120. Upon receiving the manifests of the presentities 130, the watcher application 120 may be dynamically reconfigured based on the types of presentities 130 in the subscribed list. Processing moves from operation 512 to operation 514.

At operation 514, presence server 102 receives updates from various presentities 130 through presence application 232. The updates may include presence information such as location or availability of a presentity 130, a trigger event associated with the presentity 130, and the like. Processing moves from operation 514 to decision operation 516.

At decision operation 516, a determination is made whether a presentity 130, from which updated presence information is received, is included on the subscribed presentities list of the watcher application 120. If the presentity 130 is not on the list, the presence application 232 stores updated information in presentity store 106 in following operation 518. Otherwise, processing advances from decision operation 516 to operation 520.

At operation 520, presence server 102 provides watcher application 120 with the updated presence information associated with the presentity 130 on the subscribed list. After operation 520, processing moves to a calling process for further actions.

The operations included in process 500 are for illustration purposes. Providing a dynamically configurable presence service may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method for providing a presence service comprising:
receiving a list of descriptions for available presentities;
automatically grouping the available presentities based on a description of each available presentity;
providing access to the available presentities based on their grouping, wherein the access is dynamically configured depending on the description of each available presentity.

2. The method of claim 1, further comprising:
grouping the available presentities based at least one of: on a predetermined set of rules and a watcher defined set of rules.

3. The method of claim 1, wherein the descriptions of the available presentities include at least one from a set of: a name for each description, an address of at least one application associated with an action related to a particular presentity type, at least one parameter associated with the application, at least one icon to be used in a watcher application user interface (UI), and an authorization definition.

4. The method of claim 3, wherein the access is dynamically configured by providing the one application associated with the action to the watcher application UI.

5. The method of claim 1, wherein the available presentities include at least one from a set of: a person, a device associated with a watcher, a system associated with the watcher, and a resource associated with a presence system.

6. The method of claim 1, wherein access to the available presentities is provided through an IP Multimedia System (IMS) based presence platform.

7. The method of claim 1, further comprising:
dynamically reconfiguring the access in response to a change in one or more of the available presentity groups.

8. A system for providing distributed access services between a watcher and a presentity, comprising:
a presence service management component configured to:
receive a registration request for a presentity type from a presence application;
register the presentity type with a presentity manifest store, wherein the registration includes presentity manifest information;
receive a registration request for the presentity of a registered type from the presence application; and
register the presentity with a presentity store; and
a presence server configured to:
provide a watcher application with a list of available presentities from the presentity store;
receive a request for subscription to a group of presentities among the list of available presentities from the watcher application;
subscribe the watcher application to the requested group of presentities such that the watcher application is dynamically configured based on the presentity manifest information associated with the presentities; and
in response to receiving updated presence information from the presentities, provide the presence information to the watcher application.

9. The system of claim 8, further comprising:
a directory service configured to:
receive the presentity registration request from the presence application; and
manage the registration of the presentity with the presentity store.

10. The system of claim 8, wherein the type of presentities includes at least one of: a commercial resource and an automated service resource.

11. The system of claim 9, wherein the presence service and the presence service management component are configured to communicate through one or more SIP sessions using an IMS infrastructure.

12. The system of claim 8, wherein the presentities include at least one from a set of: a device associated with a watcher, a system associated with the watcher, and a resource associated with a presence system that are configured to communicate with the presence application through one of a wired and wireless network.

13. The system of claim 8, wherein the watcher application is dynamically configured based on the manifest information for a newly added presentity type.

14. The system of claim 8, wherein the watcher application is dynamically configured based on at least one action included in the manifest information, and wherein the at least one action is associated with a presentity type.

15. The system of claim 8, wherein the presence service is configured to subscribe the watcher application to the requested group of presentities based on an authorization definition included in the manifest information associated with the presentities.

16. A watcher application for providing presence information to a watcher in a dynamically configurable presence system, comprising:
means for retrieving a list of available presentities from a presence service;
means for subscribing to a group of presentities among the list of available presentities;
means for retrieving manifest information associated with each of the subscribed presentities;
means for providing access to an application associated with a subscribed presentity through a watcher application UI; and
means for receiving presence information from the subscribed presentities.

17. The watcher application of claim 16, further comprising:
means for presenting the received presence information and a plurality of actions associated with the presentity to a user, wherein the means for presenting is configured based on the manifest information; and
means for providing a user selected action to the dynamically configurable presence system for execution.

18. The watcher application of claim 16, wherein the manifest information includes at least one of: a name for a presentity type, an address of at least one application associated with an action related to the presentity type, at least one parameter associated with the application, at least one icon to be used by the means for presenting, and an authorization definition.

19. The watcher application of claim 18, wherein the one application is arranged to facilitate through the presentity one of: a voice communication, a video communication, an image acquisition, and an electronic control action.

20. The watcher application of claim 16, wherein the means for providing access to the application associated with the subscribed presentity is arranged to reconfigure the watcher application UI in response to one of: addition of a new presentity type, removal of an existing presentity type, and modification of manifest information associated with a presentity type.
